(19) United States
(12) Patent Application Publication
(10) Pub. No.: US 2014/0307639 A1
(43) Pub. Date: Oct. 16, 2014

(54) APPARATUS AND METHOD FOR ALLOCATING CHANNELS IN COMMUNICATION SYSTEM

(71) Applicant: Electronics and Telecommunications Research Institute, Daejeon (KR)

(72) Inventors: Hoiyoon JUNG, Daejeon (KR); Jungsun UM, Daejeon (KR); Sunghyun HWANG, Daejeon (KR); Jaehyun PARK, Busan (KR); Sunmin LIM, Daejeon (KR); Byungjang JEONG, Daejeon (KR)

(21) Appl. No.: 13/944,019

(22) Filed: Jul. 17, 2013

(30) Foreign Application Priority Data
Apr. 10, 2013 (KR) 10-2013-0039081

(51) Int. Cl. H04W 72/04

(52) U.S. Cl. CPC H04W 72/042
USPC 370/329

(57) ABSTRACT

An apparatus for allocating channels in a communication system includes: a receiving unit configured to receive terminal information from a plurality of terminals, the terminal information containing information on data transmission/reception schemes of the terminals; a checking unit configured to check the data transmission/reception schemes of the terminals and check interference at channels allocated to the terminals; and an allocating unit configured to allocate primary and secondary channels to the terminals based on the data transmission/reception schemes of the terminals, change the primary and secondary channels based on the interference, and allocate the changed channels to the terminals; and a transmitting unit configured to transmit channel allocation information on the primary and secondary channels allocated to the terminals to the terminals.

### CROSS-REFERENCE TO RELATED APPLICATIONS

The present application claims priority of Korean Patent Application No. 10-2013-0039081, filed on Apr. 10, 2013, which is incorporated herein by reference in its entirety.

### BACKGROUND OF THE INVENTION

1. Field of the Invention

Exemplary embodiments of the present invention relate to a communication system; and, more particularly, to an apparatus and method for dynamically allocating multiple channels to transmit/receive data between an access point (hereafter, referred to as ‘AP’) and a plurality of terminals, for example, stations (hereafter, referred to as ‘STAs’) while minimizing interference between channels to the STAs.

2. Description of Related Art

In a current communication system, research has been actively conducted to provide various qualities of services (hereafter, referred to as ‘QoS’) having a high transmission rate to users. Examples of the communication system may include a wireless local area network (hereafter, referred to as ‘WLAN’) system. In the WLAN system, research has been actively conducted on a variety of methods for stably transmitting large-volume data at high speed through limited resources. In particular, research has been conducted on data transmission through wireless channels. Recently, there have been proposed a variety of methods for normally transmitting and receiving large-volume data by effectively using limited wireless channels in the WLAN system.

In the current communication system, there have been proposed a variety of methods for transmitting and receiving large-volume data to a plurality of users by effectively using limited frequency channels. In particular, there have been proposed methods for normally transmitting and receiving data by effectively using limited frequency channels, when a base station, for example, an access point (hereafter, referred to as ‘AP’) and a plurality of terminals corresponding to a plurality of users, for example, stations (hereafter, referred to as ‘STAs’) transmit and receive large-volume data through the limited frequency channels in the current WLAN system.

In the current WLAN system, when large-volume data are transmitted/received through limited frequency channels allocated to the plurality of STAs, data transmission/reception schemes between the AP and the STAs, or particularly, data transmission/reception schemes of the STAs are different from each other. Thus, there have not yet been proposed a specific method for allocating frequency channels to the STAs according to the data transmission/reception schemes of the STAs. Furthermore, when interference occurs at the channels allocated to the STAs, data may not be normally transmitted/received because of the interference.

Therefore, there is a demand for a method for allocating channels to a plurality of STAs in consideration of transmission/reception schemes of the STAs, when large-volume data are transmitted and received through limited frequency channels between an AP and the STAs in a communication system, for example, a WLAN system. Furthermore, there is a demand for a channel allocation method for normally transmitting and receiving data by minimizing interference at the frequency channels allocated to the plurality of STAs.

### SUMMARY OF THE INVENTION

An embodiment of the present invention is directed to an apparatus and method for allocating channels in a communication system.

Another embodiment of the present invention is directed to an apparatus and method for normally transmitting/receiving large-volume data by minimizing interference at frequency channel for transmitting/receiving large-volume data in a communication system.

Another embodiment of the present invention is directed to an apparatus and method for allocating limited frequency channels to a plurality of terminals in consideration of data transmission/reception schemes of the terminals.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for allocating channels in a communication system includes: a receiving unit configured to receive terminal information from a plurality of terminals, the terminal information containing information on data transmission/reception schemes of the terminals; a checking unit configured to check the data transmission/reception schemes of the terminals and check interference at channels allocated to the terminals; and an allocating unit configured to allocate primary and secondary channels to the terminals based on the data transmission/reception schemes of the terminals, change the primary and secondary channels based on the interference, and allocate the changed channels to the terminals; and a transmitting unit configured to transmit channel allocation information on the primary and secondary channels allocated to the terminals.

In accordance with another embodiment of the present invention, an apparatus for receiving channels in a communication system includes: a generating unit configured to generate terminal information containing information on data transmission/reception schemes of a plurality of terminals; a transmitting unit configured to transmit the terminal information to an AP; and a receiving unit configured to receive channel allocation information on primary and secondary channels allocated to the terminals according to the data transmission/reception schemes of the terminals and a data transmission/reception scheme of the AP. When interference at the primary channel is checked, the secondary channel is changed to the primary channel, and the primary channel where the interference exists is changed to the secondary channel.

In accordance with another embodiment of the present invention, a method for allocating channels in a communication system includes: receiving terminal information from a plurality of terminals, the terminal information containing information on data transmission/reception schemes of the terminals; checking the data transmission/reception schemes of the terminals, and checking interference at the channels allocated to the terminals; allocating primary and secondary channels to the terminals based on the data transmission/reception schemes of the terminals, changing the primary and secondary channels based on the interference, and allocating the changed channels to the terminals; and transmitting channel allocation information on the primary and secondary channels allocated to the terminals to the terminals.

In accordance with another embodiment of the present invention, a method for receiving channels in a communication system includes: generating terminal information containing information on data transmission/reception schemes of a plurality of terminals; transmitting the terminal information to an AP; and receiving channel allocation information on primary and secondary channels allocated to the terminals, according to the data transmission/reception schemes of the terminals and a data transmission/reception scheme of the AP. When interference at the primary channel is checked, the secondary channel is changed to the primary channel, and the primary channel where the interference exists is changed to the secondary channel.

### BRIEF DESCRIPTION OF THE DRAWINGS

FIG. 1 schematically illustrates the architecture of a communication system in accordance with an embodiment of the present invention.

FIGS. 2 to 13 schematically illustrate data transmission/reception through allocated channels in the communication system in accordance with the embodiment of the present invention.

FIG. 14 schematically illustrates the architecture of an AP to allocate channels in the communication system in accordance with the embodiment of the present invention.

FIG. 15 schematically illustrates a channel allocation process of the AP in the communication system in accordance with the embodiment of the present invention.

FIG. 16 schematically illustrates the architecture of STAs to receive a channel in the communication system in accordance with the embodiment of the present invention.

FIG. 17 schematically illustrates a process of STAs to receive channels in the communication system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The embodiments of the present invention provide an apparatus and method for allocating channels in a communication system, for example, a WLAN system. In the embodiments of the present invention, the WLAN system will be taken as an example for description. However, the channel allocation apparatus and method in accordance with the embodiments of the present invention may be applied to other communication systems.

Furthermore, the embodiments of the present invention provide an apparatus and method for allocating frequency channels in IEEE 802.11 systems as a communication system, for example, a WLAN system. The channel allocation apparatus and method in accordance with the embodiments of the present invention may minimize interference at limited frequency channels which are allocated to a plurality of terminals, for example, stations (referred to as ‘STAs’) corresponding to a plurality of users in a communication system, for example, a WLAN system in order to transmit/receive large-volume data. The communication system in accordance with the embodiments of the present invention allocates frequency channels for data transmission and reception between a base station, for example, an access point (referred to as ‘AP’) and a plurality of STAs. At this time, as the channels are allocated to the STAs to minimize interference during the data transmission and reception, large-volume data may be normally transmitted and received.

Furthermore, the embodiments of the present invention provide an apparatus and method for allocating limited frequency channels to a plurality of STAs corresponding to a plurality of users to transmit/receive large-volume data in a communication system, for example, a WLAN system. More specifically, the channel allocation apparatus and method allocates channels such that the STAs normally transmit/receive data according to various data transmission/reception schemes.

In the communication system, for example, in a WLAN system, an AP allocates channels to a plurality of STAs according to data transmission/reception schemes of the STAs, for example, multi-channel transmission, multi-user transmission, multi-antenna transmission, frequency division multiple access (FDMA) and the like, and large-volume data are normally transmitted and received through the data transmission/reception schemes corresponding to the STAs through the allocated channels.

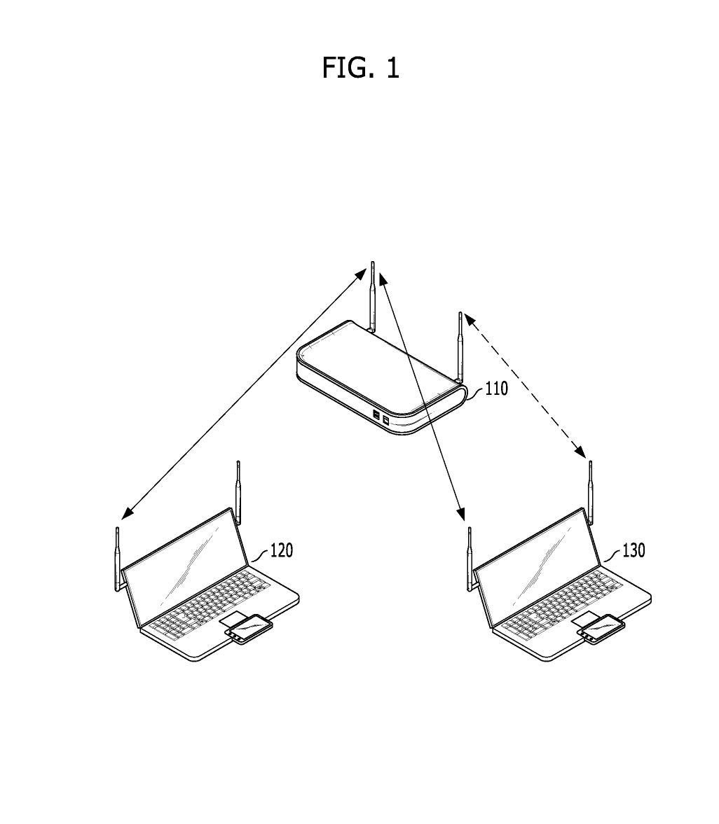

In the embodiments of the present invention, when an AP receives terminal information, containing information data transmission/reception schemes and positions of a plurality of STAs, from the plurality of STAs in a communication system such as a WLAN system, for example, an environment in which IEEE 802.11 systems coexist, the AP allocates channels on the basis of the terminal information to minimize interference at frequency channels, and thus the AP and the STAs normally transmit/receive large-volume data. Now, referring to FIG. 1, a communication system in accordance with an embodiment of the present invention will be described in detail.

FIG. 1 schematically illustrates the architecture of a communication system in accordance with an embodiment of the present invention.

Referring to FIG. 1, the communication system includes an AP 110 and a plurality of terminals, for example, first and second STAs 120 and 130. The AP 110 is configured to transmit data corresponding to a variety of communication services through channels, in order to provide the communication service to users, and the first and second STAs 120 and 130 are configured to receive data from the AP 110 through the channels.

The AP 110 and the STAs 120 and 130 transmit/receive data through channels allocated to the STAs 120 and 130, that is, a primary channel and a secondary channel according to data transmission/reception schemes between the AP 110 and the STAs 120 and 130, or particularly, data transmission/reception schemes of the STAs 120 and 130, for example, multi-channel transmission, multi-user transmission, multi-antenna transmission, and FDMA. In other words, the primary channel and the secondary channel are allocated in consideration of whether or not the AP 110 may support multi-channel transmission, multi-use transmission, multi-antenna transmission, and FDMA and whether or not the STAs 120 and 130 may support multi-channel transmission, multi-use transmission, multi-antenna transmission, and FDMA such that data are transmitted/received between the AP 110 and the STAs 120 and 130.

At this time, the STAs 120 and 130 transmit information on the data transmission/reception schemes thereof, that is, information on multi-channel transmission, multi-user transmission, multi-antenna transmission, and FDAM and terminal information containing position information thereof to the AP 110. The AP allocates the primary and secondary channels to the STAs 120 and 130 in consideration of the terminal information, checks primary and secondary channels available for data transmission/reception by transmitting/receiving request-to-send (RTS) messages and clear-to-send (CTS) messages to/from the STAs 120 and 130, and then transmits/receives data through the available primary and secondary channels.

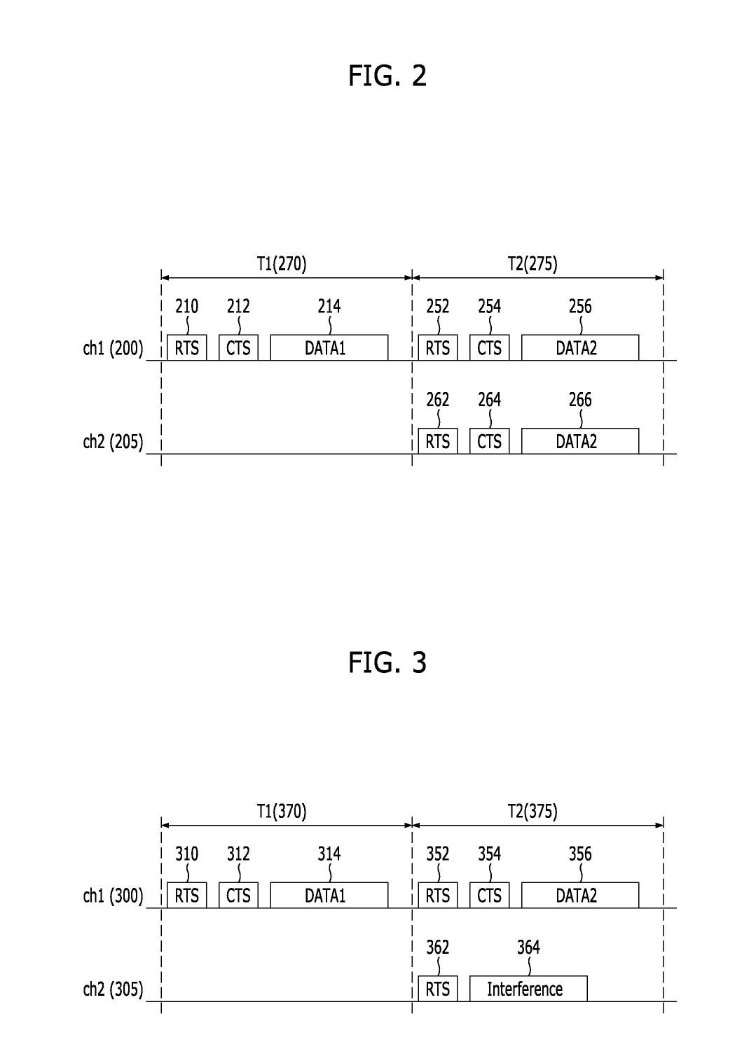

The communication system in accordance with the embodiment of the present invention allocates channels that one AP 100 and a plurality of STAs 120 and 130 transmit/receive data while minimizing interference therebetween. For example, the communication system allocates primary and secondary channels, and then normally transmits/receives data through the allocated primary and secondary channels. At this time, the communication system checks interference between the channels allocated to the STAs 120 and 130 and determines channels available for normal data transmission/reception. The interference is checked through whether or not RTS messages and CTS messages are normally transmitted/received between the AP 110 and the STAs 120 and 130, clear channel assessment (CCA) of the STAs 120 and 130, and network allocation vectors (NAV) on the network between the AP 110 and the STAs 120 and 130. Now, referring to FIGS. 2 to 13, the operation of allocating primary and secondary channels and transmitting/receiving data through the allocated primary and secondary channels in the communication system in accordance with the embodiment of the present invention will be described in more detail.

FIGS. 2 to 13 schematically illustrate data transmission/reception through allocated channels in the communication system in accordance with the embodiment of the present invention. For convenience of description, the following descriptions will be focused on a case in which, when multiple users, that is, a plurality of STAs, for example, first and second STAs transmit/receive data to/from one AP in the communication system, the first STA has a priority of RTS message transmission over the second STA through random backoff.

First, referring to FIG. 2, when the AP supports multi-channel transmission, multi-user transmission, multi-antenna transmission, and FDMA and thus may transmit/receive data through the multi-channel transmission, multi-user transmission, multi-antenna transmission, and FDMA, the first STA does not support the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, only a first channel 200 is allocated to the first STA which does not support the multi-channel transmission, and the first channel 200 and a second channel 205 are allocated as a primary channel and a secondary channel, respectively, to the second STA which supports the multi-channel transmission.

The AP and the STAs transmit/receive RTS messages and CTS messages through the allocated primary and secondary channels. More specifically, between the AP and the first STA, an RTS message 210 and a CTS message 212 are transmitted/received through the first channel 200 at a first time interval T1 270, and data DATA1 214 corresponding to the first STA are then transmitted/received through the first channel 200. As the AP and the first STA transmit/receive the RTS message 210 and the CTS message 212 through the first channel 200 at the first time internal T1 270, the AP and the first STA check the first channel 200 as a channel through which data may be transmitted/received between the AP and the first STA, and transmit/receive the data DATA1 214 through the checked first channel 200. At this time, since the first STA does not support the multi-channel transmission, the first STA transmits/receives the data DATA1 214 corresponding to the first STA by transmitting/receiving the RTS message 210 and the CTS message 212 only through the first channel 200 at the first time interval T1 270.

Between the AP and the second STA, RTS messages 252 and 262 and CTS messages 254 and 264 are transmitted/received through the first channel 200 as the primary channel and the second channel 205 as the secondary channel at a second time interval T2 275, and data DATA2 256 and 266 corresponding to the second STA are transmitted/received through the first channel 200 as the primary channel and the second channel 205 as the secondary channel. As the AP and the second STA transmit/receive the RTS messages 252 and 262 and the CTS messages 254 and 264 through the first channel 200 as the primary channel and the second channel 205 as the secondary channel at the second time interval T2 275, the AP and the second STA check the first channel 200 and the second channel 205 as channels available for data transmission/reception between the AP and the second STA, and transmit/receive the data DATA2 256 and 266 through the checked first and second channels 200 and 205. At this time, since the second STA supports the multi-channel transmission, the second STA transmits/receives the data DATA2 256 and 266 corresponding to the second STA by transmitting/receiving the RTS messages 252 and 262 and the CTS messages 254 and 264 to/from the AP through the first channel 200 as the primary channel and the second channel 205 as the secondary channel at the second time interval T2 275.

Referring to FIG. 3, when the AP supports multi-channel transmission, multi-user transmission, multi-antenna transmission, and FDMA, the first STA does not support the multi-channel transmission, and the second STA supports the multi-channel transmission in the communication system as described with reference to FIG. 2, the STAs transmit terminal information, containing information on whether or not the STAs support the multi-channel transmission, to the AP, and primary and secondary channels are allocated to the STAs in response to the terminal information. At this time, only a first channel 300 is allocated to the first STA which does not support the multi-channel transmission, and the first channel 300 and a second channel 305 are allocated as a primary channel and a secondary channel, respectively, to the second STA which supports the multi-channel transmission.

Between the AP and the first STA, an RTS message 310 and a CTS message 312 are transmitted/received through the first channel 300 at a first time internal T1 370, and data DATA1 314 corresponding to the first STA are transmitted/received through the first channel 300. As the AP and the first STA transmit/receive the RTS message 310 and the CTS message 312 through the first channel 300 at the first time interval T1 370, the AP and the first STA check the first channel 300 as a channel available for data transmission/reception between the AP and the first STA, and transmit/receive the data DATA1 314 through the checked first channel 300. At this time, since the first STA does not support multi-channel transmission, the first STA transmits/receives the data DATA1 314 corresponding to the first STA by transmitting/receiving the RTS message 310 and the CTS message 312 to/from the AP only through the first channel 300 at the first time interval T1 370.

Between the AP and the second STA, RTS messages 352 and 362 are transmitted/received through the first channel 300 as the primary channel and the second channel 305 as the secondary channel at a second time interval T2 375. At this time, as interference 364 exists in the second channel 305 as the secondary channel, a CTS message 354 is transmitted/received only through the first channel 300 as the primary channel, and data DATA2 356 corresponding to the second STA are transmitted/received only through the first channel 300 as the primary channel. Although the AP and the second STA transmit/receive the RTS messages 352 and 362 through the first channel 300 as the primary channel and the second channel 305 as the secondary channel at the second time interval T2 375, the CTS message 354 cannot be transmitted/received through the second channel 305 as the secondary channel because the interference 364 exists in the second channel as the secondary channel, but is transmitted/received only through the first channel 300 as the primary channel. Thus, the AP and the second STA check the first channel 300 as a channel available for data transmission/reception between the AP and the second STA, and transmit/receive the data DATA2 356 only through the checked first channel 300.

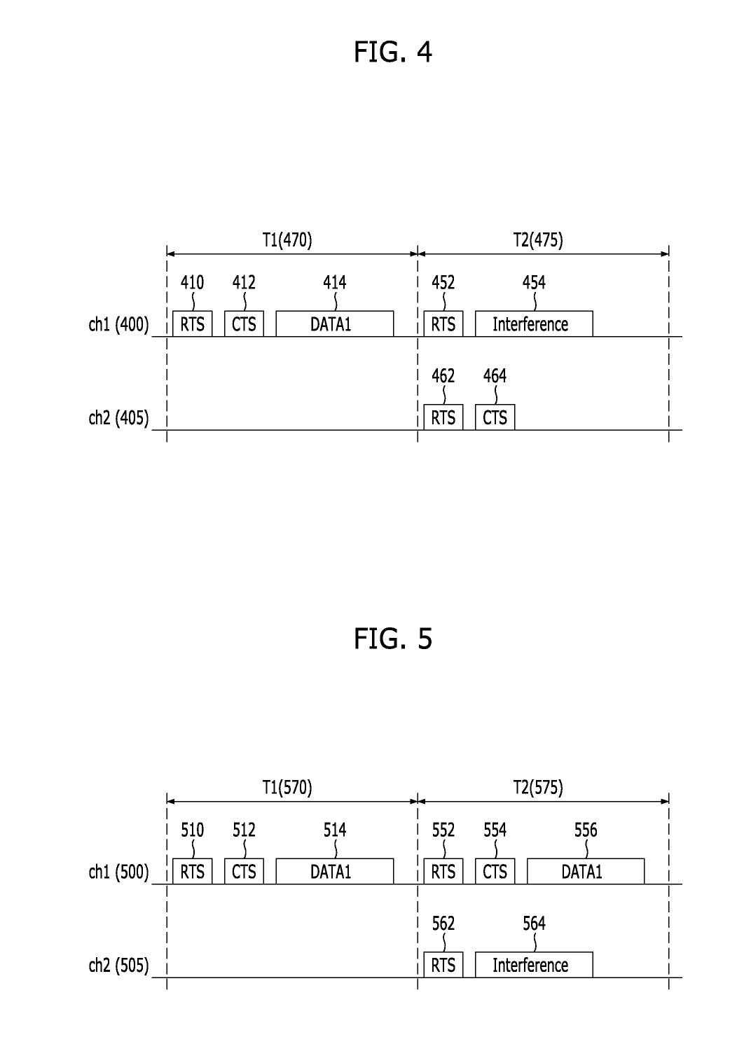

Referring to FIG. 4, when the AP supports multi-channel transmission, multi-user transmission, multi-antenna transmission, and FDMA, the first STA does not support the multi-channel transmission, and the second STA supports the multi-channel transmission in the communication system as described with reference to FIG. 2, the STAs transmit terminal information, containing information on whether or not the STAs support the multi-channel transmission, to the AP, and primary and secondary channels are allocated to the STAs in response to the terminal information. At this time, only a first channel 400 is allocated to the first STA which does not support the multi-channel transmission, and the first channel 400 and a second channel 405 are allocated as a primary channel and a secondary channel, respectively, to the second STA which supports the multi-channel transmission.

Between the AP and the first STA, an RTS message 410 and a CTS message 412 are transmitted/received through the first channel 400 at a first time internal T1 470, and data DATA1 414 corresponding to the first STA are transmitted/received through the first channel 400. As the AP and the first STA transmit/receive the RTS message 410 and the CTS message 412 through the first channel 400 at the first time interval T1 470, the AP and the first STA check the first channel 400 as a channel available for data transmission/reception between the AP and the first STA, and transmit/receive the data DATA1 414 through the checked first channel 400. At this time, since the first STA does not support the multi-channel transmission, the first STA transmits/receives the data DATA1 414 corresponding to the first STA by transmitting/receiving the RTS message 410 and the CTS message 412 to/from the AP only through the first channel 400 at the first time interval T1 470.

Between the AP and the second STA, RTS messages 452 and 462 are transmitted/received through the first channel 400 as the primary channel and the second channel 405 as the secondary channel at a second time interval T2 475. At this time, as interference 454 exists in the first channel 400 as the primary channel, a CTS message 464 is transmitted/received only through the second channel 405 as the secondary channel. Although the AP and the second STA transmit/receive the RTS messages 452 and 462 through the first channel 400 as the primary channel and the second channel 405 as the secondary channel at the second time interval T2 475, the CTS message 464 cannot be transmitted/received through the first channel 400 as the primary channel because the interference 454 exists in the first channel 400 as the primary channel, but is transmitted/received only through the second channel 405 as the secondary channel. Thus, although the AP and the second STA check the second channel 405 as a channel available for data transmission/reception between the AP and the second STA, the data corresponding to the second STA may not be transmitted/received between the AP and the second STA at the second time interval T2 475 because the first channel 400 as the primary channel is not included in channels available for data transmission/reception.

However, when the second STA cannot transmit/receive a CTS message to/from the AP through the first channel 400 as the primary channel because the interference 454 exists in the first channel 400 as the primary channel and transmits/receives the CTS message 464 to/from the AP only through the second channel 405 as the secondary channel, the communication system in accordance with the embodiment of the present invention changes the primary channel of the second STA from the first channel 400 to the second channel 405, and the AP and the second STA transmit/receive data through the second channel 405 as the changed primary channel at the second time interval T2 475.

In the communication system in accordance with the embodiment of the present invention, when the second STA supports multiple channels and normally transmits/receives data through the second channel 405 allocated as the secondary channel rather than the first channel 400 allocated as the primary channel, that is, when the data transmission/reception performance of the communication system is improved through the change of the primary channel of the second STA, the primary channel of the second STA is changed to the second channel 405 as the secondary channel, that is, the second channel 405 is allocated as the primary channel of the second STA and the first channel 400 is allocated as the secondary channel of the second STA. In this way, after the primary and secondary channels are changed and new primary and secondary channels are allocated to the second STA, the AP and the STAs transmit/receive RTS messages and CTS messages through the new primary and secondary channels. When all of the RTS messages and the CTS messages are normally transmitted/received through the new primary and secondary channels, the AP and the STAs transmit/receive data as described with reference to FIG. 2. Now, the operation of changing a primary channel to transmit/receive data in the communication system in accordance with the embodiment of the present invention will be described in more detail.

First, referring to FIG. 5, when the AP supports multi-channel transmission, multi-user transmission, multi-antenna transmission, and FDMA, the first STA does not support the multi-channel transmission, and the second STA supports the multi-channel transmission in the communication system as described with reference to FIG. 2, the STAs transmit terminal information, containing information on whether or not the STAs support the multi-channel transmission, to the AP, and primary and secondary channels are allocated to the STAs in response to the terminal information. At this time, only a first channel 500 is allocated to the first STA which does not support the multi-channel transmission.

Furthermore, as described with reference to FIG. 2, the first channel 500 and a second channel 505 are allocated as a primary channel and a secondary channel to the second STA which supports the multi-channel transmission. Then, since data cannot be normally transmitted/received through the primary channel because of interference at the primary channel or the like, the second channel 505 is changed from the secondary channel to the primary channel, and the first channel 500 is changed from the primary channel to the secondary channel. That is, the primary channel of the second STA is changed to normally transmit/receive data between the second STA and the AP, and the first channel 500 and the second channel 505 are allocated as the secondary channel and the primary channel, respectively, to the second STA which supports the multi-channel transmission.

The change of the primary channel of the second STA is performed when data cannot be normally transmitted/received because of interference at the primary channel of the second STA or the like. In this case, the secondary channel of the second STA is changed to a new primary channel of the second STA, and the previous primary channel of the second STA is changed to the secondary channel of the second STA, in order to allocate the new primary channel to the second STA. Furthermore, the interference at the primary channel of the second STA is checked through whether or not the RTS message and the CTS message are normally transmitted/received between the AP and the second STA, CCA of the STAs at the primary channel of the second STA, and NAV at the primary channel of the second STA.

Between the AP and the first STA, an RTS message 510 and a CTS message 512 are transmitted/received through the first channel 500 at a first time interval T1 570, and data DATA1 514 corresponding to the first STA are transmitted/received through the first channel 500. Since the second STA cannot normally transmit/receive data through the second channel 505 as the primary channel of the second STA because of interference 564 at the second channel 505 at the second time interval T2 575, the AP and the first STA transmit/receive an RTS message 552 and a CTS message 554 through the first channel 500 at the second time interval T2 575 after random backoff, and then transmit/receive data DATA1 556 corresponding to the first STA through the first channel 500. As the AP and the first STA transmit/receive the RTS messages 510 and 552 and the CTS messages 512 and 554 through the first channel 500 at the first time interval T1 570 and the second time interval T2 575, the AP and the first STA check the first channel 500 as a channel available for data transmission/reception between the AP and the firs STA, and transmit/receive the data DATA1 514 and 556 through the checked first channel 500. At this time, since the first STA does not support multi-channel transmission, the first STA transmits/receives the data DATA1 514 and 556 corresponding to the first STA by transmitting/receiving the RTS messages 510 and 552 and the CTS messages 512 and 554 to/from the AP only through the first channel 500 at the first time interval T1 570 and the second time interval T2 575, respectively.

Between the AP and the second STA, an RTS message 562 is transmitted through the second channel 505 as the primary channel at the second time interval T2 574. At this time, since interference 564 exists in the second channel 505 as the primary channel, a CTS message cannot be transmitted/received through the second channel 505 as the primary channel. Thus, data cannot be transmitted/received through the second channel 505 as the primary channel at the second time interval T2 575. At this time, since the second STA cannot normally transmit/receive data through the second channel as the primary channel of the second STA because of the interference 564 at the second channel 505 as the primary channel at the second time interval T2 575, the RTS message 552 and the CTS message 554 are transmitted/received between the AP and the first STA through the first channel 500 at the second time interval T2 575, and the data DATA1 556 corresponding to the first STA are then transmitted/received through the first channel 500.

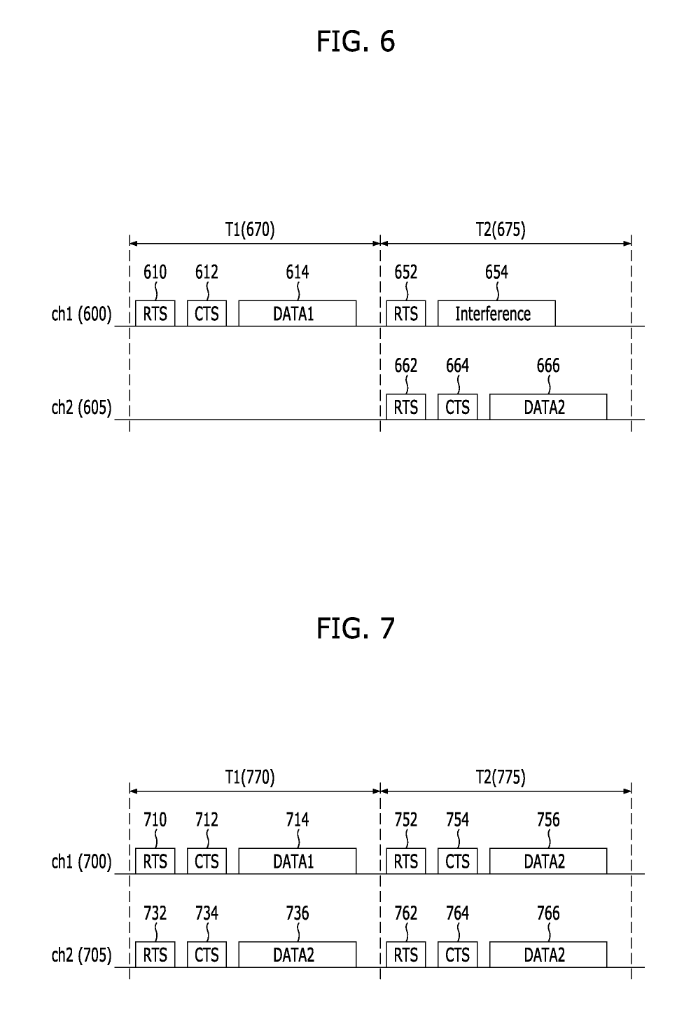

Referring to FIG. 6, when the AP supports multi-channel transmission, multi-user transmission, multi-antenna transmission, and FDMA, the first STA does not support the multi-channel transmission, and the second STA supports the multi-channel transmission in the communication system as described with reference to FIG. 2, the STAs transmit terminal information, containing information on whether or not the STAs support the multi-channel transmission, to the AP, and primary and secondary channels are allocated to the STAs in response to the terminal information. At this time, only a first channel 600 is allocated to the first STA which does not support the multi-channel transmission, and the first channel 600 and a second channel 605 are allocated as a secondary channel and a primary channel, respectively, to the second STA which supports the multi-channel transmission.

Since data cannot be normally transmitted/received through the primary channel because of interference at the primary channel after the first and second channels 600 and 605 are allocated as the primary and secondary channels as described with reference to FIG. 2, the second channel 605 is changed from the secondary channel to the primary channel, and the first channel 600 is changed from the primary channel to the secondary channel. That is, the primary channel of the second STA is changed to normally transmit/receive data between the second STA and the AP, and the first channel 600 and the second channel 605 are allocated as the secondary channel and the primary channel, respectively, to the second STA which supports the multi-channel transmission. Since the change of the primary channel of the second STA has been already described above, the detailed descriptions thereof are omitted herein.

Between the AP and the first STA, an RTS message 610 and a CTS message 612 are transmitted/received through the first channel 600 at the first time interval T1 670, and data DATA1 614 corresponding to the first STA are transmitted/received through the first channel 600. As the AP and the first STA transmit/receive the RTS message 610 and the CTS message 612 through the first cannel 600 at the first time interval T1 670, the AP and the first STA check the first channel 600 as a channel available for data transmission/reception between the AP and the first STA, and transmit/receive the data DATA1 614 through the checked first channel 600. At this time, since the first STA does not support the multi-channel transmission, the first STA transmits/receives the data DATA1 614 corresponding to the first STA by transmitting/receiving the RTS message 610 and the CTS message 612 to/from the AP only through the first channel 600.

Between the AP and the second STA, RTS messages 652 and 662 are transmitted/received through the secondary channel 605 as the primary channel and the first channel 600 as a secondary channel at the second time interval T2 675. At this time, as interference 654 exists in the first channel 600 as the secondary channel, a CTS message 664 is transmitted/received only through the second channel 605 as the primary channel, and data DATA2 666 corresponding to the second STA are transmitted/received only through the second channel 605 as the primary channel. Although the AP and the second STA transmit/receive the RTS messages 652 and 662 through the second channel 605 as the primary channel and the first channel 600 as the secondary channel at the second time interval T2 675, the CTS message 664 cannot be transmitted/received through the first channel 600 as the secondary channel because the interference 654 exists in the first channel 600 as the secondary channel, but is transmitted/received only through the second channel as the primary channel. Thus, the AP and the second STA check the second channel 605 as a channel available for data transmission/reception between the AP and the second STA, and transmit/receive the data DATA2 666 only through the checked second channel 605. Now, the operation of changing a primary channel to transmit/receive data when the AP supports multi-user transmission in the communication system in accordance with the embodiment of the present invention will be described in more detail.

Referring to FIG. 7, when the AP supports multi-channel transmission, multi-user transmission, multi-antenna transmission, and FDMA and thus may transmit/receive data through the multi-channel transmission, multi-user transmission, multi-antenna transmission, and FDMA, the first STA does not support the multi-channel transmission, and the second STA supports the multi-channel transmission in the communication system as described with reference to FIG. 2, the STAs transmit terminal information, containing information on whether or not the STAs support the multi-channel transmission, to the AP, and primary and secondary channels are allocated to the STAs in response to the terminal information. In this case, only a first channel 700 is allocated to the first STA which does not support the multi-channel transmission, and the first channel 700 and a second channel 705 are allocated as a secondary channel and a primary channel, respectively, to the second STA which supports the multi-channel transmission. That is, the primary channel of the second STA is changed in order to normally transmit/receive data between the second STA and the AP as described with reference to FIGS. 5 and 6, and the second channel 705 is allocated as the primary channel to the second STA.

The AP and the STAs transmit/receive RTS messages and CTS messages through the allocated primary and secondary channels. More specifically, between the AP and the first STA, an RTS message 710 and a CTS message 712 are transmitted/received through the first channel 700 and data DATA1 714 corresponding to the first STA is transmitted/received through the first channel 700 at a first time interval T1 770. As the AP and the first STA transmit/receive the RTS message 710 and the CTS message 712 through the first channel 700 at the first time interval T1 770, the AP and the first STA check the first channel 700 as a channel available for data transmission/reception between the AP and the first STA, and transmit/receive the data DATA1 714 through the checked first channel 700. At this time, since the first STA does not support the multi-channel transmission, the first STA transmits/receives the data DATA1 714 corresponding to the first STA by transmitting/receiving the RTS message 710 and the CTS message 712 to/from the AP only through the first channel 700 at the first time interval T1 770.

As the AP supports multi-user transmission and the second STA supports multi-channel transmission, an RTS message 732 and a CTS message 734 are transmitted/received between the AP and the second STA through the second channel as the primary channel at the first time interval T1 770, and data DATA2 736 corresponding to the second STA are transmitted through the second channel 705 as the primary channel. Furthermore, RTS messages 752 and 762 and CTS messages 754 and 764 are transmitted/received between the AP and the second STA through the second channel 705 as the primary channel and the first channel 700 as the secondary channel at a second time interval T2 775, and data DATA2 756 and 766 corresponding to the second STA are transmitted/received through the second channel 705 as the primary channel and the first channel 700 as the secondary channel.

As the AP and the second STA transmit/receive the RTS message 732 and the CTS message 734 through the second channel 705 as the primary channel at the first time interval T1 770 and transmit/receive the RTS messages 752 and 762 and the CTS messages 754 and 764 through the second channel 705 as the primary channel and the first channel 700 as the secondary channel at the second time interval T2 775, the AP and the second STA check the second channel 705 at the first time interval T1 770 and the second and first channels 705 and 700 at the second time interval T2 775 as channels available for data transmission/reception between the AP and the second STA, and transmit/receive the data DATA2 736, 756, and 766 through the checked second and first channels 705 and 700 at the respective time intervals 770 and 775. That is, as the second STA supports multi-channel transmission and the AP supports multi-user transmission, the second STA transmits/receives the data DATA2 736 corresponding to the second STA by transmitting/receiving the RTS message 732 and the CTS message 734 to/from the AP through the second channel 705 as the primary channel at the first time interval T1 770, and transmits/receives the data DATA2 756 and 766 corresponding to the second STA by transmitting/receiving the RTS message 752 and 762 and the CTS messages 754 and 764 to/from the AP through the second channel 705 as the primary channel and the first channel 700 as the secondary channel at the second time interval T2 775.

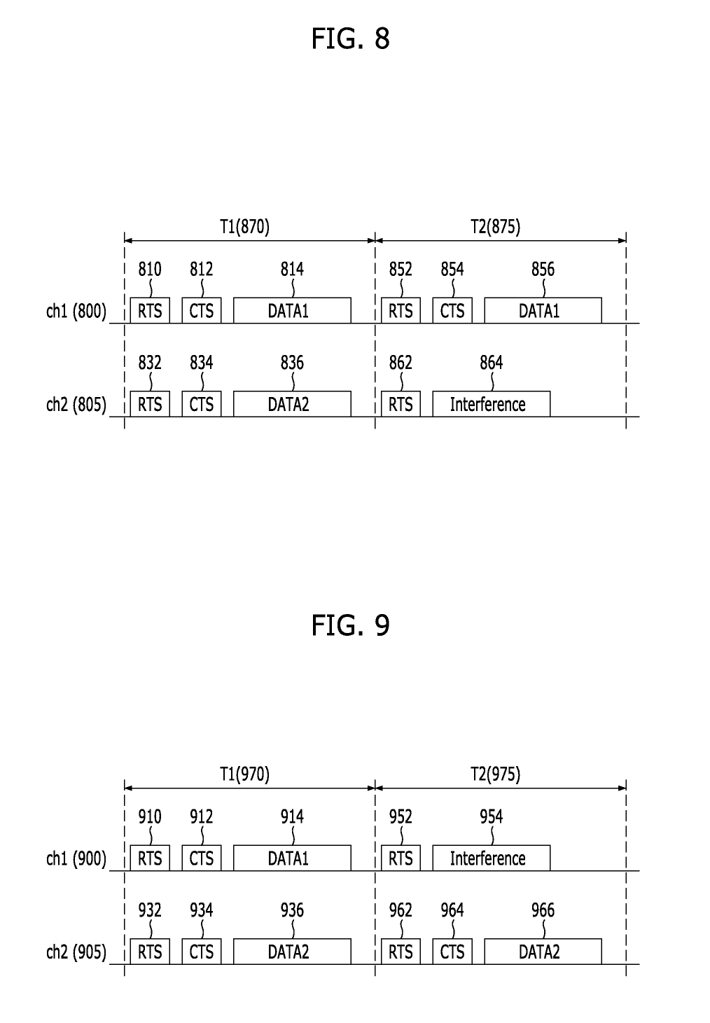

Referring to FIG. 8, when the AP supports multi-channel transmission, multi-user transmission, multi-antenna transmission, and FDMA and thus may transmit/receive data through the multi-channel transmission, multi-user transmission, multi-antenna transmission, and FDMA, the first STA does not support the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, only a first channel 800 is allocated to the first STA which does not support the multi-channel transmission, and the first channel 800 and a second channel 805 are allocated as a secondary channel and a primary channel, respectively, to the second STA which supports the multi-channel transmission. That is, the primary channel of the second STA is changed in order to normally transmit/receive data between the second STA and the AP as described with reference to FIGS. 5 and 6, and the second channel 805 is allocated as the primary channel to the second STA.

Between the AP and the first STA, an RTS message 810 and a CTS message 812 are transmitted/received through the first channel 800 at a first time interval T1 870, and data DATA1 814 corresponding to the first STA is transmitted/received through the first channel 800. Since the second STA cannot normally transmit/receive data through the second channel 805 as the primary channel of the second STA because of interference 864 at the second channel 805 at a second time interval T2 875, the AP and the first STA transmit/receive an RTS message 852 and a CTS message 854 through the first channel 800 at the second time interval T2 875 after random backoff, and transmit/receive data DATA1 856 corresponding to the first STA through the first channel 800. As the AP and the first STA transmit/receive the RTS messages 810 and 852 and the CTS message 812 and 854 through the first channel 800 at the first time interval T1 870 and the second time interval T2 875, the AP and the first STA check the first channel 800 as a channel available for data transmission/reception between the AP and the first STA, and transmit/receive the data DATA1 814 and 856 through the checked first channel 800. At this time, since the first STA does not support multi-channel transmission, the first STA transmits/receives the data DATA1 814 and 856 corresponding to the first STA by transmitting/receiving the RTS messages 810 and 852 and the CTS messages 812 and 854 to/from the AP only through the first channel 800 at the first time interval T1 870 and the second time interval T2 875.

As the AP supports multi-user transmission and the second STA supports multi-channel transmission, an RTS message 832 and a CTS message 834 are transmitted/received between the AP and the second STA through the second channel 805 as the primary channel at the first time interval T1 870, and data DATA2 836 corresponding to the second STA are transmitted/received through the second channel 805 as the primary channel. Furthermore, an RTS message 862 is transmitted/received between the AP and the second STA through the second channel 805 as the primary channel at the second time interval T2 875. At this time, as a CTS message cannot be transmitted/received through the second channel 805 as the primary channel because interference 864 exists in the second channel 805 as the primary channel, data cannot be transmitted/received through the second channel 805 as the primary channel at the second time interval T2 875. Since the second STA cannot normally transmit/receive data through the second channel 805 as the primary channel of the second STA because of the interference 864 at the second channel 805 as the primary channel at the second time interval T2 875, the AP and the first STA transmit/receive the RTS message 852 and the CTS message 854 through the first channel 800 at the second time interval T2 875, and then transmit/receive the data DATA1 856 corresponding to the first STA through the first channel 800.

That is, since the second STA supports multi-channel transmission and the AP supports multi-user transmission, the AP and the second STA transmit/received the RTS message 832 and the CTS message 834 through the second channel 805 as the primary channel at the first time interval T1 870. Thus, the AP and the second STA check the second channel 805 at the first time interval T1 870 as a channel available for data transmission/reception between the AP and the second STA, and transmit/receive the data DATA2 836 through the checked second channel 805 at the first time interval T1 870.

Referring to FIG. 9, when the AP supports multi-channel transmission, multi-user transmission, multi-antenna transmission, and FDMA and thus may transmit/receive data through the multi-channel transmission, multi-user transmission, multi-antenna transmission, and FDMA, the first STA does not support the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, only a first channel 900 is allocated to the first STA which does not support multi-channel transmission, and the first channel 900 and a second channel 905 are allocated as a secondary channel and a primary channel, respectively, to the second STA which supports multi-channel transmission. That is, the primary channel of the second STA is changed in order to normally transmit/receive data between the second STA and the AP as described with reference to FIGS. 5 and 6, and the second channel 905 is allocated as the primary channel to the second STA.

Between the AP and the first STA, an RTS message 910 and the CTS message 912 are transmitted/received through the first channel 900 at a first time interval T1 970, and data DATA1 914 corresponding to the first STA is then transmitted/received through the first channel 900. As the AP and the first STA transmit/receive the RTS message 910 and the CTS message 912 through the first channel 900 at the first time interval T1 970, the AP and the first STA check the first channel 900 as a channel available for data transmission/reception between the AP and the first STA, and transmit/receive the data DATA1 914 through the checked first channel 900. At this time, since the first STA does not support multi-channel transmission, the first STA transmits/receives the data DATA1 914 corresponding to the first STA by transmitting/receiving the RTS message 910 and the CTS message 912 to/from the AP only through the first channel 900 at the first time interval T1 970.

As the AP supports multi-user transmission and the second STA supports multi-channel transmission, an RTS message 932 and a CTS message 934 are transmitted between the AP and the second STA through the second channel 905 as the primary channel at the first time interval T1 970, and data DATA2 936 corresponding to the second STA are then transmitted/received through the second channel 905 as the primary channel. Furthermore, the AP and the second STA transmit/receive RTS messages 952 and 962 through the second channel 905 as the primary channel and the first channel 90 as the secondary channel at a second time interval T2 975. At this time, as interference 954 exists in the first channel 900 as the secondary channel, the CTS message 964 is transmitted/received only through the second channel 905 as the primary channel, and data DATA2 966 corresponding to the second STA are then transmitted/received only through the second channel 905 as the primary channel.

Since the second STA supports multi-channel transmission and the AP supports multi-user transmission, the AP and the second STA transmit/receive the RTS message 932 and the CTS message 934 through the second channel 905 as the primary channel at the first time interval T1 970, and transmit/receive the RTS messages 952 and 962 through the second channel 905 as the primary channel and the first channel 900 as the secondary channel at the second time interval T2 975. However, since the interference 954 exists in the first channel 900 as the secondary channel, the CTS message 964 cannot be transmitted/received through the first channel 900 as the secondary channel, but is transmitted/received only through the second channel 900 as the primary channel. Accordingly, the AP and the second STA check the second channel 905 at the first time interval T1 970 and the second channel 905 at the second time interval T2 975 as channels available for data transmission/reception between the AP and the second STA, and transmit/receive the data 936 and 966 through the checked second channel 905 at the respective time intervals 970 and 975. So far, the data transmission/reception process when only the second STA as an arbitrary STA among a plurality of STAB supports multi-channel transmission has been described for convenience of explanation. Hereafter, however, a data transmission/reception process when the STAB support multi-channel transmission, for example, the first and second STAB support multi-channel transmission will be described in detail.

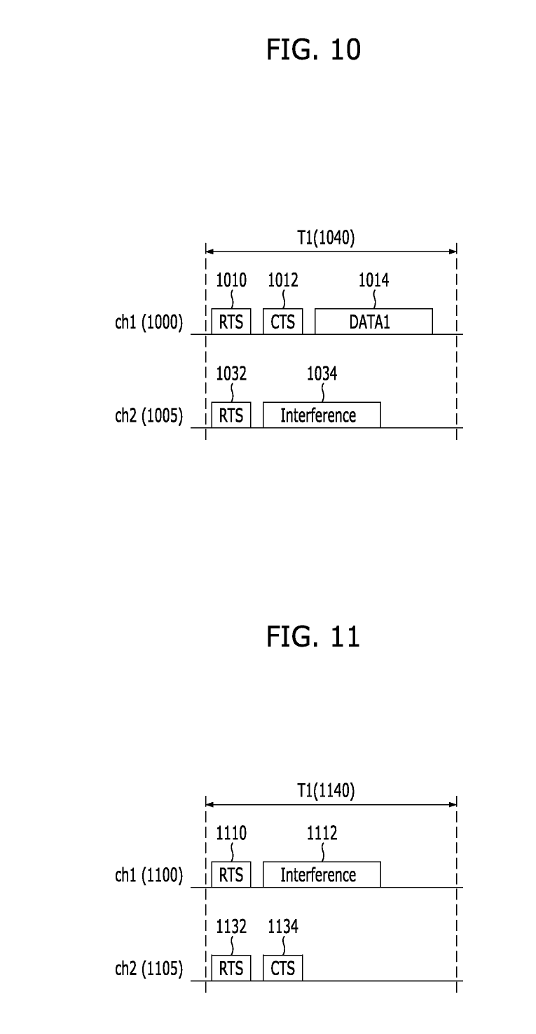

Referring to FIG. 10, when the AP supports multi-channel transmission, multi-user transmission, multi-antenna transmission, and FDMA and thus may transmit/receive data through the multi-channel transmission, multi-user transmission, multi-antenna transmission, and FDMA, the first STA supports the multi-channel transmission, and the second STA supports the multi-channel transmission in the communication system, the STAB transmit terminal information, containing information on whether or not the STAB support the multi-channel transmission, to the AP, and primary and secondary channels are allocated to the STAB in response to the terminal information. At this time, a first channel 1000 and a second channel 1005 are allocated as a primary channel and a secondary channel, respectively, to the first STA which supports multi-channel transmission, and the first channel 1000 and the second channel 1005 are allocated as a primary channel and a secondary channel, respectively, to the second STA which supports multi-channel transmission.

Between the AP and the first STA, RTS messages 1010 and 1032 are transmitted/received through the first channel 1000 as the primary channel and the second channel 1005 as the secondary channel at a first time interval T1 1040. At this time, as interference 1034 exists in the second channel 1005 as the secondary channel, the AP and the first STA transmit/receive a CTS message 1012 only through the first channel 1000 as the primary channel, and then transmit/receive data DATA1 1014 corresponding to the first STA only through the first channel 1000 as the primary channel. Although the AP and the first STA transmit/receive the RTS messages 1010 and 1032 through the first channel 1000 as the primary channel and the second channel 1005 as the secondary channel at the first time interval T1 1040, the AP and the first STA cannot transmit/receive a CTS message through the second channel 1005 as the secondary channel because the interference 1034 exists in the second channel 1005 as the secondary channel, but transmit/receive the CTS message 1012 only through the first channel 1000 as the primary channel. Thus, the AP and the first STA check the first channel 1000 as a channel available for data transmission/reception between the AP and the first STA, and transmit/receive the data DATA1 1014 only through the checked first channel 1000.

Referring to FIG. 11, when the AP supports multi-channel transmission, multi-user transmission, multi-antenna transmission, and FDMA and thus may transmit/receive data through the multi-channel transmission, multi-user transmission, multi-antenna transmission, and FDMA, the first STA supports the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, a first channel 1100 and a second channel 1105 are allocated as a primary channel and a secondary channel, respectively, to the first STA which supports multi-channel transmission, and the first channel 1100 and the second channel 1105 are allocated as a primary channel and a secondary channel, respectively, to the second STA which supports multi-channel transmission.

Between the AP and the first STA, RTS messages 1110 and 1132 are transmitted/received through the first channel 1100 as the primary channel and the second channel 1105 as the secondary channel at a first time interval T1 1140. At this time, as interference 1112 exists in the first channel 1100 as the primary channel, the AP and the first STA transmit/receive a CTS message 1134 only through the second channel 1105 as the secondary channel. Although the AP and the first STA transmit/receive the RTS messages 1110 and 1132 through the first channel 1100 as the primary channel and the second channel 1105 as the secondary channel at the first time interval T1 1140, the AP and the first STA cannot transmit/receive a CTS message through the first channel 1100 as the primary channel because the interference 1112 exists in the first channel 1100 as the primary channel, but transmit/receive the CTS message 1134 only through the second channel 1105 as the secondary channel. Thus, the AP and the first STA check the secondary channel 1105 as a channel available for data transmission/reception between the AP and the first STA. However, since the first channel 110 as the primary channel is not contained in channels available for data transmission/reception, the data corresponding to the first STA may not be transmitted between the AP and the first STA at the first time interval T1 1140. At this time, since the first channel 1100 is the primary channel of the second STA like the first STA, data may not be transmitted/received between the AP and the second STA at the first time interval T1 1140.

That is, data may not be transmitted/received between the AP and the second STA as well as the first STA through the first and second channels 1100 and 1105 at the first time interval T1 1140. Thus, the communication system in accordance with the embodiment of the present invention changes the primary channels of the STAs to normally transmit/receive data through the changed primary channels, when the RTS messages and the CTS messages are not normally transmitted/received to/from the AP through the primary channels because of interference in the primary channels and the data are not normally transmitted/received. Since the change of the primary channel of the STAs has been described above, the detailed descriptions thereof are omitted herein. Hereafter, the operation of transmitting/receiving data through the change of the primary channel of the STAs which support multi-channel transmission will be described in more detail.

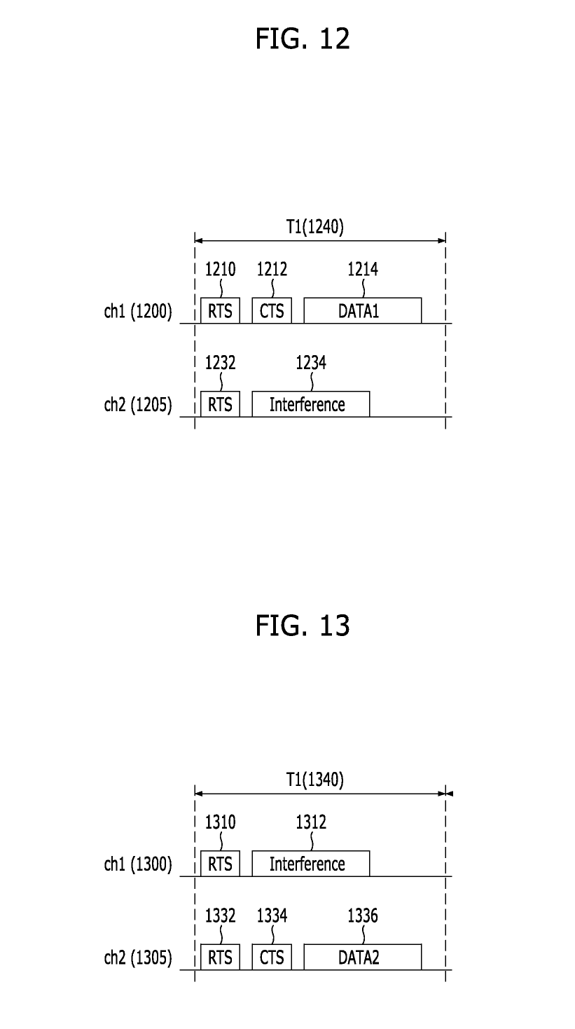

Referring to FIG. 12, when the AP supports multi-channel transmission, multi-user transmission, multi-antenna transmission, and FDMA and thus may transmit/receive data through the multi-channel transmission, multi-user transmission, multi-antenna transmission, and FDMA, the first STA supports the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, a first channel 1200 and a second channel 1205 are allocated as a primary channel and a secondary channel, respectively, to the first STA which supports multi-channel transmission.

Furthermore, the first channel 1200 and the second channel 1205 are allocated as the primary channel and the secondary channel, respectively, to the second STA which supports multi-channel transmission. Then, since data cannot be normally transmitted/received through the primary channel because of interference in the primary channel, the second channel 1205 is changed from the secondary channel to the primary channel, and the first channel 1200 is changed from the primary channel to the secondary channel. That is, the primary channel of the second STA is changed in order to normally transmit/receive data between the second STA and the AP, and the first channel 1200 and the second channel 1205 are allocated as the secondary channel and the primary channel, respectively, to the second STA which supports multi-channel transmission.

The change of the primary channel of the second STA is performed when data cannot be normally transmitted/received because of interference at the primary channel of the second STA as described above. The secondary channel of the second STA is changed to a new primary channel of the second STA, and the previous primary channel of the second STA is changed to the secondary channel of the second STA to allocate the new primary channel to the second STA. Furthermore, the interference at the primary channel of the second STA is checked through whether or not RTS messages and CTS messages are normally transmitted/received between the AP and the second STA, CCA of the STAs at the primary channel of the second STA, and NAV at the primary channel of the second STA.

The AP and the first STA transmit/receive RTS messages 1210 and 1232 through the first channel 1200 as the primary channel and the second channel 1205 as the secondary channel at a first time interval T1 1240. At this time, as interference 1234 exists in the second channel 1205 as the secondary channel, the AP and the first STA transmit/receive a CTS message 1212 only through the first channel 1200 as the primary channel, and then transmit/receive data DATA1 1214 corresponding to the first STA only through the first channel 1200 as the primary channel. Although the AP and the first STA transmit/receive the RTS messages 1210 and 1232 through the first channel 1200 as the primary channel and the second channel 1205 as the secondary channel at the first time interval T1 1240, the AP and the first STA cannot transmit/receive the CTS message 1212 through the second channel 1205 as the secondary channel because of the interference 1234 at the second channel 1205 as the secondary channel, but transmit/receive the CTS message 1212 only through the first channel 1200 as the primary channel. Thus, the AP and the first STA check the first channel 1200 as a channel available for data transmission/reception between the AP and the first STA, and transmit/receive the data DATA1 1214 only through the checked first channel 1200.

As the interference 1234 exists in the second channel 1205 as the primary channel of the second STA, the AP and the second STA cannot normally transmit/receive an RTS message and a CTS message through the second channel 1205 as the primary channel. Thus, the data corresponding to the second STA are not transmitted/received through the second channel 1205 as the primary channel of the second STA.

Referring to FIG. 13, when the AP supports multi-channel transmission, multi-user transmission, multi-antenna transmission, and FDMA and thus may transmit/receive data through the multi-channel transmission, multi-user transmission, multi-antenna transmission, and FDMA, the first STA supports the multi-channel transmission, and the second STA supports the multi-channel transmission in the communication system, the STAs transmit terminal information, containing information on whether or not the STAs support the multi-channel transmission, to the AP, and primary and secondary channels are allocated to the STAs in response to the terminal information. At this time, a first channel 1300 and a second channel 1305 are allocated as a primary channel and a secondary channel, respectively, to the first STA which supports multi-channel transmission, and the first channel 1300 and the second channel 1305 are allocated as the primary channel and the secondary channel, respectively, to the second STA which supports multi-channel transmission.

Since data cannot be normally transmitted/received through the primary channel of the second STA because of interference at the primary channel after the first channel 130 and the second channel 1305 are allocated as the primary channel and the secondary channel to the second STA, the second channel 1305 is changed from the secondary channel to the primary channel, and the first channel 1300 is changed from the primary channel to the secondary channel. That is, the primary channel of the second STA is changed to normally transmit/receive data between the second STA and the AP, and the first channel 1300 and the second channel 1305 are allocated as the secondary channel and the primary channel, respectively, to the second STA which supports multi-channel transmission. Since the change of the primary channel of the second STA has been described above, the detailed descriptions thereof are omitted herein.

The AP and the first STA transmit/receive RTS messages 1310 and 1332 through the first channel 1300 as the primary channel and the second channel 1305 as the secondary channel at a first time interval T1 1340. At this time, as interference 1312 exists in the first channel 1300 as the primary channel, the AP and the first STA transmit/receive a CTS message 1334 only through the second channel 1305 as the secondary channel. Although the AP and the first STA transmit/receive the RTS messages 1310 and 1305 through the first channel 1300 as the primary channel and the second channel 1305 as the secondary channel at the first time interval T1 1340, the AP and the first STA cannot transmit/receive the CTS message 1334 through the first channel 1300 as the primary channel because of the interference 1312 at the first channel 1300 as the primary channel, but transmit/receive the CTS message 1334 only through the second channel 1305 as the secondary channel. Thus, the AP and the first STA check the second channel 1305 as a channel available for data transmission/reception between the AP and the first STA. However, since the first channel 1300 as the primary channel is not included in channel available for data transmission/reception, the data corresponding to the first STA are not transmitted/received between the AP and the first STA at the first time interval T1 1140.

At this time, since the interference 1312 exists in the first channel 1300 as the secondary channel of the second STA at the first time interval T1 1140, the AP and the second STA normally transmit/receive the RTS message and the CTS message through the second channel 1305 as the primary channel of the second STA. Thus, the AP and the second STA check the second channel 1305 as a channel available for data transmission/reception between the AP and the second STA, and transmit/receive the data DATA2 1336 corresponding to the second STA through the second channel 1305 as the checked primary channel at the first time interval T1 1140.

In this way, the communication system in accordance with the embodiment of the present invention allocates the primary and secondary channels to the STAs based on the transmission/reception schemes of the STAs, for example, the information on whether or not the STAs may support multi-channel transmission, multi-user transmission, multi-antenna transmission, and FDMA, and the terminal information containing position information of the STAs, and the data transmission/reception scheme of the AP, for example, the information on whether or not the AP may support multi-channel transmission, multi-user transmission, multi-antenna transmission, and FDMA. In order to normally transmit/receive data between the AP and the STAs, the communication system changes the primary channels of the STAs in consideration of interference at the allocated channels, and then allocates the changed primary channels to the corresponding STAs. Then, data are transmitted/received between the AP and the STAs through the allocated channels.

That is, the communication system in accordance with the embodiment of the present invention dynamically allocates the channels of the STAs, or particularly, the primary channels, in order to maximize the data transmission/reception efficiency between the AP and the STAs and the performance of the communication system, for example, to maximum the sum of data transmission/reception rates of the STAs, the entire QoS of the communication system, and power saving between the AP and the STAs. In other words, the secondary channels of the STAs are changed to the primary channels and dynamically allocated, based on interference at the channels.

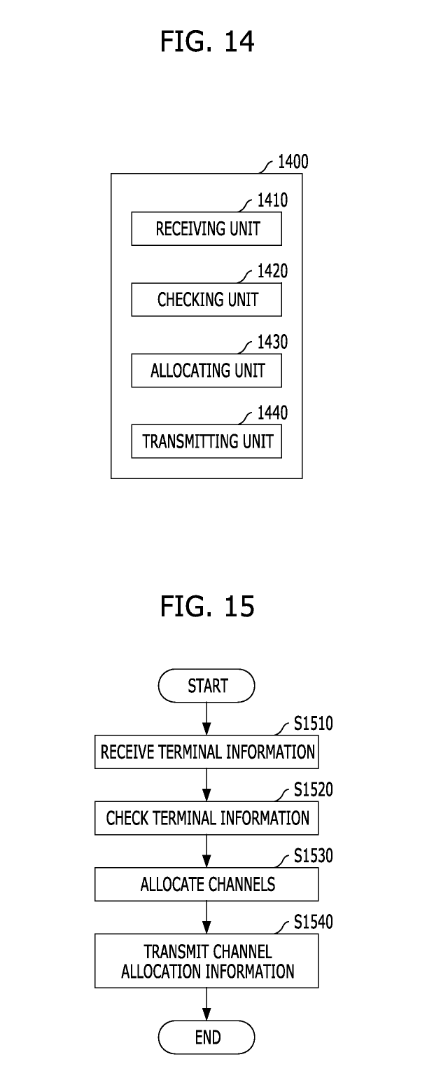

The communication system in accordance with the embodiment of the present invention allocates the primary and secondary channels to the STAs using the terminal information of the STAs as described above. At this time, based on the terminal information of the STAs, for example, the data transmission/reception schemes and the position information of the STAs, the STAs are grouped into STA groups, and the primary and secondary channels are allocated to the STA groups of the STAs. For example, when adjacent STAs among the STAs are grouped into one STA group based on the position information of the STAs, it is highly likely that interference will occur at channels allocated to the adjacent STAs. Thus, the primary and secondary channels are allocated to the STA group of the adjacent STAs in consideration of the interference. Furthermore, according to the data transmission/reception information of STAs among the STAs, for example, information on whether or not the STAs support multi-channel transmission, the STAs are grouped into STA groups, and the primary and secondary channels are allocated to a STA group of STAs which support multi-channel transmission and a STA group of the STAs which do not support multi-channel transmission. At this time, one channel is dynamically allocated as an operation channel to an STA which does not support multi-channel transmission, and the primary and secondary channels are dynamically allocated to an STA which supports multi-channel transmission as described above. Now, referring to FIG. 14, an apparatus for allocating channels to a plurality of STAs in the communication system in accordance with the embodiment of the present invention, for example, the AP will be described in more detail.

FIG. 14 schematically illustrates the architecture of the AP to allocate channels in the communication system in accordance with the embodiment of the present invention.

Referring to FIG. 14, the AP 1400 includes a receiving unit 1410, a checking unit 1420, an allocating unit 1430, and a transmitting unit 1440. The receiving unit 1410 is configured to receive information on data transmission/reception schemes of STAs, for example, information on whether or not the STAs may support multi-channel transmission, multi-user transmission, multi-antenna transmission, and FDMA and terminal information containing position information of the STAs. The checking unit 1420 is configured to check the positions and data transmission/reception schemes of the STAs, or particularly, information on whether or not the STAs may support multi-channel transmission through the terminal information, and check interference at channels allocated to the STAs. The allocating unit 1430 is configured to dynamically allocate channels, for example, primary and secondary channels to the STAs based on the terminal information, that is, the positions and data transmission/reception schemes of the STAs. The transmitting unit 1440 is configured to transmit the channel allocation information on the primary and secondary channels allocated to the STAs.

The AP allocates the primary and secondary channels to the STAs according to the data transmission/reception schemes of the AP, for example, information on whether or not the AP supports multi-channel transmission, multi-user transmission, multi-antenna transmission, and FDMA and the positions and data transmission/reception schemes of the STAs, for example, information on whether or not the STAs support multi-channel transmission, multi-user transmission, multi-antenna transmission, and FDMA. Furthermore, in order to overcome difficulties in data transmission/reception between the AP and the STAs due to interference in the channels allocated to the STAs, or particularly, interference at the primary channels of the STAs, the AP changes the primary channels allocated to the STAs based on the interference at the primary channels of the STAs, and allocates new primary channels to the STAs. For example, the AP may allocate the secondary channels allocated to the STAs as the primary channels of the STAs. Since the change of the primary channel of the STAs has been described above, the detailed descriptions thereof are omitted herein. Now, referring to FIG. 15, the operation of the AP to allocate channels to a plurality of channels in the communication system in accordance with the embodiment of the present invention will be described in detail.

FIG. 15 schematically illustrates the channel allocation process of the AP in the communication system in accordance with the embodiment of the present invention.

Referring to FIG. 15, the AP receives information on data transmission/reception schemes of STAs, for example, information on whether or not the STAs may support multi-channel transmission, multi-user transmission, multi-antenna transmission, and FDMA and terminal information containing position information of the STAs, at step S1510.

At step S1520, the AP checks the positions and data transmission/reception schemes of the STAs, or particularly, whether or not the STAs may support multi-channel transmission through the terminal information, and checks interference at channels allocated to the STAs.

At step S1530, the AP dynamically allocates channels, for example, primary and secondary channels to the STAs, based on the terminal information, that is, the positions and data transmission/reception schemes of the STAs. At step S1540, the AP transmits the channel allocation information on the primary and secondary channels allocated to the STAs to the STAs.

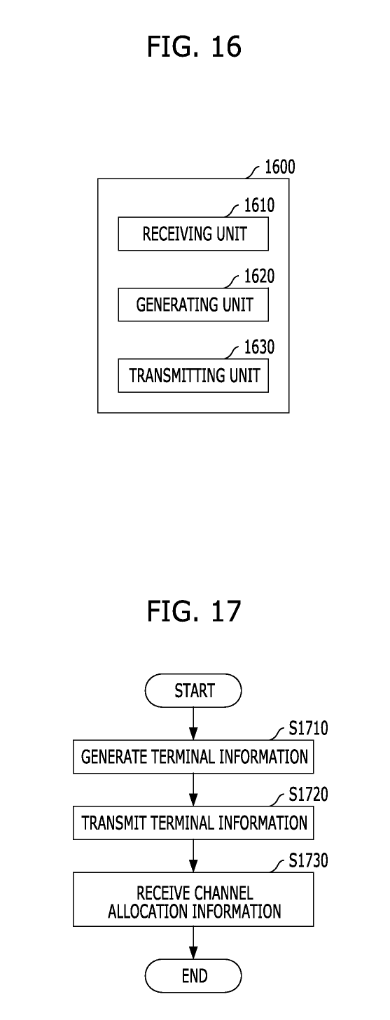

The AP allocates the primary and secondary channels to the STAs according to the data transmission/reception schemes of the AP, for example, the information on whether or not the AP supports multi-channel transmission, multi-user transmission, multi-antenna transmission, and FDMA and the positions and data transmission/reception schemes of the STAs, for example, the information on whether or not the STAs support multi-channel transmission, multi-user transmission, multi-antenna transmission, and FDMA. Furthermore, in order to overcome difficulties in data transmission/reception between the AP and the STAs due to interference at the channels allocated to the STAs, or particularly, interference at the primary channels of the STAs, the AP changes the primary channels allocated to the STAs based on the interference at the primary channels of the STAs, and allocates new primary channels to the STAs. For example, the AP may allocate the secondary channels allocated to the STAs as the primary channels of the STAs. Since the change of the primary channel of the STAs has been described above, the detailed descriptions thereof are omitted herein. Now, referring to FIG. 16, an apparatus for receiving a channel in the communication system in accordance with the embodiment of the present invention, for example, a plurality of STAs will be described in detail.

FIG. 16 schematically illustrates the architecture of STAs to receive a channel in the communication system in accordance with the embodiment of the present invention.

Referring to FIG. 16, the STA 1200 includes a receiving unit 1610, a generating unit 1620, and a transmitting unit 1630. The receiving unit 1610 is configured to receive channel allocation information on channels allocated to the STA from an AP, for example, primary and secondary channels. The generating unit 1620 is configured to generate information on data transmission/reception schemes of the STA, for example, information on whether or not the STA may support multi-channel transmission, multi-user transmission, multi-antenna transmission, and FDMA and terminal information containing position information of the STA. The transmitting unit 1230 is configured to transmit the terminal information to the AP.

According to the data transmission/reception schemes of the AP, for example, the information on whether or not the AP supports multi-channel transmission, multi-user transmission, multi-antenna transmission, and FDMA and the positions and data transmission/reception schemes of the STAs, for example, the information whether or not the STAs support multi-channel transmission, multi-user transmission, multi-antenna transmission, and FDMA, the primary and secondary channels are allocated to the STA. Furthermore, in order to overcome difficulties in data transmission and reception between the AP and the STAs due to interference at the channels allocated to the STA, or particularly, interference in the primary channels of the STA, the allocated primary channel is changed based on the interference in the primary channel of the STA, and a new primary channel is allocated to the STA. For example, the allocated secondary channel is allocated as the new primary channel to the STA. Since the change of the primary channel of the STA has been described above, the detailed descriptions thereof are omitted herein. Now, referring to FIG. 17, the operation of the STAs to receive channels in the communication system in accordance with the embodiment of the present invention will be described in detail.

FIG. 17 schematically illustrates the process of STAs to receive channels in the communication system in accordance with the embodiment of the present invention.

Referring to FIG. 17, the STA generates information on data transmission/reception schemes of the STA, for example, information on whether or not the STA may support multi-channel transmission, multi-user transmission, multi-antenna transmission, and FDMA and terminal information containing the position information of the STAs, at step S1710.

At step S1720, the STA transmits the generated terminal information to an AP. At step S1730, the STA receives channel allocation information on the channels allocated to the STA, for example, primary and secondary channels from the AP.

According to the data transmission/reception schemes of the AP, for example, the information on whether or not the AP supports multi-channel transmission, multi-user transmission, multi-antenna transmission, and FDMA and the positions and data transmission/reception schemes of the STAs, for example, the information whether or not the STAs support multi-channel transmission, multi-user transmission, multi-antenna transmission, and FDMA, the primary and secondary channels are allocated to the STA. Furthermore, in order to overcome difficulties in data transmission and reception between the AP and the STAs due to interference at the channels allocated to the STA, or particularly, interference in the primary channels of the STA, the allocated primary channel is changed based on the interference in the primary channel of the STA, and a new primary channel is allocated to the STA. For example, the allocated secondary channel is allocated as the new primary channel to the STA. Since the change of the primary channel of the STA has been described above, the detailed descriptions thereof are omitted herein.

In accordance with the embodiments of the present invention, the communication system supports data transmission/reception schemes of a plurality of STAs by allocating frequency channels to the STAs in consideration of data transmission/reception schemes of the STAs. Accordingly, the communication system may normally transmit/receive large-volume data to/from a plurality of STAs having various data transmission/reception schemes through the frequency channels.

Furthermore, the communication system allocates channels to a plurality of STAs on the basis of terminal information on the STAs so as to minimize interference at the channels allocated to the STAS. Therefore, when data are transmitted/received through the channels allocated to the STAs, interference at the allocated channels may be maximized to normally transmit/receive large-volume data. Accordingly, the data transmission/reception performance may be improved through limited frequency channel, and the efficiency of the limited frequency channels may be maximized.

While the present invention has been described with respect to the specific embodiments, it will be apparent to those skilled in the art that various changes and modifications may be made without departing from the spirit and scope of the invention as defined in the following claims.

What is claimed is:

1. An apparatus for allocating channels in a communication system, comprising:
a receiving unit configured to receive terminal information from a plurality of terminals, the terminal information containing information on data transmission/reception schemes of the terminals;
a checking unit configured to check the data transmission/reception schemes of the terminals and check interference at channels allocated to the terminals; and
an allocating unit configured to allocate primary and secondary channels to the terminals based on the data transmission/reception schemes of the terminals, change the primary and secondary channels based on the interference, and allocate the changed channels to the terminals; and
a transmitting unit configured to transmit channel allocation information on the primary and secondary channels allocated to the terminals to the terminals.

2. The apparatus of claim 1, wherein the allocating unit allocates the primary and secondary channels to the terminals according to multi-channel transmission, multi-user transmission, multi-antenna transmission, and frequency division multiple access (FDMA) of the terminals.

3. The apparatus of claim 2, wherein the allocating unit allocates the primary and secondary channels to the terminals according to multi-channel transmission, multi-user transmission, multi-antenna transmission, and FDMA of an access point (AP) to transmit/receive data to/from the terminals.

4. The apparatus of claim 3, wherein the AP and the terminals transmit/receive data through the primary channels of the respective terminals according to the multi-user transmission at the same time interval.

5. The apparatus of claim 1, wherein the interference is checked through one or more of transmission/reception of request-to-send (RTS) messages and clear-to-send (CTS) messages at the channels allocated to the terminals, clear channel assessment (CCA) of the terminals, and network allocation vector (NAV) at the channels allocated to the terminals.

6. The apparatus of claim 1, wherein when the interference at the primary channel is checked, the allocating unit changes the secondary channel to the primary channel, and changes the primary channel where the interference exists to the secondary channel.

7. The apparatus of claim 1, wherein the terminal information contains position information of the terminals, and
the terminals are grouped into terminal groups based on the information on the data transmission/reception schemes and the position information, in order to minimize the interference.

8. The apparatus of claim 7, wherein the allocating unit allocates the primary and secondary channels of the terminals for each of the terminal groups.

9. An apparatus for receiving channels in a communication system, comprising:
a generating unit configured to generate terminal information containing information on data transmission/reception schemes of a plurality of terminals;
a transmitting unit configured to transmit the terminal information to an AP; and
a receiving unit configured to receive channel allocation information on primary and secondary channels allocated to the terminals according to the data transmission/reception schemes of the terminals and a data transmission/reception scheme of the AP,
wherein when interference at the primary channel is checked, the secondary channel is changed to the primary channel, and the primary channel where the interference exists is changed to the secondary channel.

10. The apparatus of claim 9, wherein the primary and secondary channels are allocated according to multi-channel transmission, multi-user transmission, multi-antenna transmission, and FDMA of the terminals and the AP.

11. The apparatus of claim 10, wherein the AP and the terminals transmit/receive data through the primary channels of the respective terminals according to the multi-user transmission at the same time interval.

12. The apparatus of claim 9, wherein the interference is checked through one or more of transmission/reception of RTS messages and CTS messages at the channels allocated to the terminals, CCA of the terminals, and NAV at the channels allocated to the terminals.

13. A method for allocating channels in a communication system, comprising:
receiving terminal information from a plurality of terminals, the terminal information containing information on data transmission/reception schemes of the terminals;
checking the data transmission/reception schemes of the terminals, and checking interference at the channels allocated to the terminals;
allocating primary and secondary channels to the terminals based on the data transmission/reception schemes of the terminals, changing the primary and secondary channels based on the interference, and allocating the changed channels to the terminals; and
transmitting channel allocation information on the primary and secondary channels allocated to the terminals to the terminals.

14. The method of claim 13, wherein in said allocating the primary and secondary channels to the terminals based on the data transmission/reception schemes of the terminals, changing the primary and secondary channels based on the interference, and allocating the changed channels to the terminals,
the primary and secondary channels are allocated to the terminals according to multi-channel transmission, multi-user transmission, multi-antenna transmission, and FDMA of the terminals and an AP to transmit/receive data to/from the terminals.

15. The method of claim 14, wherein the AP and the terminals transmit/receive data through the primary channels of the terminals according to the multi-user transmission at the same time interval.

16. The method of claim 13, wherein the interference is checked through one or more of transmission/reception of RTS messages and CTS messages at the channels allocated to the terminals, CCA of the terminals, and NAV at the channels allocated to the terminals.

17. The method of claim 13, wherein in said allocating the primary and secondary channels to the terminals based on the data transmission/reception schemes of the terminals, changing the primary and secondary channels based on the interference, and allocating the changed channels to the terminals,
when the interference at the primary channel is checked, the secondary channel is changed to the primary channel, and the primary channel where the interference exists is changed to the secondary channel.

18. A method for receiving channels in a communication system, comprising:
generating terminal information containing information on data transmission/reception schemes of a plurality of terminals;
transmitting the terminal information to an AP; and
receiving channel allocation information on primary and secondary channels allocated to the terminals, according to the data transmission/reception schemes of the terminals and a data transmission/reception scheme of the AP,
wherein when interference at the primary channel is checked, the secondary channel is changed to the primary channel, and the primary channel where the interference exists is changed to the secondary channel.

19. The method of claim 18, wherein the primary and secondary channels are allocated according to multi-channel transmission, multi-user transmission, multi-antenna transmission, and FDMA of the terminals and the AP.

20. The method of claim 18, wherein the interference is checked through one or more of transmission/reception of RTS messages and CTS messages at the channels allocated to the terminals, CCA of the terminals, and NAV at the channels allocated to the terminals.
